(19) United States
(12) Patent Application Publication
(10) Pub. No.: US 2020/0151828 A1
(43) Pub. Date: May 14, 2020

(54) ONLINE OPINION PLATFORM

(71) Applicant: Yee Ham CHUNG, Richmond Hill (CA)

(72) Inventor: Yee Ham CHUNG, Richmond Hill (CA)

(21) Appl. No.: 16/190,291

(22) Filed: Nov. 14, 2018

(51) Int. Cl. G06Q 50/00; G07C 13/00; G06F 17/30

(52) U.S. Cl. CPC G06Q 50/01; G06F 17/30867; G07C 13/00

(57) ABSTRACT

The present invention is a computer-implemented method of online opinion for filtering of poll respondents by demographic and credibility attributes, the method comprising steps of providing a plurality of questions by a plurality of questioners, wherein each the questions are assigned a topic; receiving a plurality of answers by a plurality of respondents, wherein each the respondents has different level of expertise in the topic; receiving a plurality of votes for the answers by the respondents; receiving a plurality of reasons for the answers or the votes by the respondents; storing a demographic profile data of the respondent at a time of response to the question, vote or provide reason; analyzing related data for the questioners and the responders; providing an answer with most votes out of all respondents, all ranked answers, all ranked reasons for each the answers; filtering the answers based on demographic settings and credibility of the respondent, wherein the filtering step comprises of creating a temporary table to estimate the data size of each of a demo filter value by a database statistic to keep data size small for high performance filtering; executing in a loop row by row for every row in the temporary table by an iterative approach to minimize work-in-progress data size and memory requirement, resulting in higher performance, and ranking the answers, wherein the ranking is by highest number of votes within the filtered set of respondents.

### FIELD OF THE INVENTION

The present invention relates in general to social networking and in specific to an online opinion platform based on filtering of respondents by demographic attributes.

### BACKGROUND OF THE INVENTION

Existing social networking websites or applications recommend to their users in many aspects of daily life. Some recommendations are results from a combination of marketing strategies, website operation strategies, and a universal collection of opinions or comments from a wide variety of users.

Currently there is no streamlined online method to obtain opinion-based and curiosity-based questions online and receive easy-to-read and trustworthy answers quickly. The existing systems have the following problems.

The currently available systems are fact-based questions and solution-oriented questions which can be fulfilled adequately by search engines, but opinion-based questions, where the asker is not looking for a single “right” answer, cannot be addressed by search adequately. These are questions where users are looking for a large number of responses, as opposed to a single best answer. For example the question “Who do you think will win the NBA finals this year?”, “What do you think is the most important trait to get promoted at work?”, etc.

Another issue of the current systems is that the people resort post questions publicly on social media, but not everyone has enough “friends” and connections to get enough responses.

Another issue which the existing systems address is that, there are sometimes personal and private questions that people do not feel comfortable posting publicly online. Even if the users manage to get a lot of responses, having to read through hundreds of free-form text messages make it challenging and time-consuming to get good insight into what the respondents are saying collectively.

Another issue of the online polls is that they have a lack of credibility and relevancy. Very little is known about who the respondents are, or whether they are even real people. There is no insight into why respondents are voting for those answers as they do not give reasons for their choices. There is no way to limit respondents to only people who are relevant to the question. For example, asking a parenting question and only seeing responses from parents. Furthermore, if the asker is controlling who can respond, it is not possible for each viewer of the results to pick his/her own different set of relevant respondents. For example, if the question is “What is the best restaurant in Toronto?”, different people viewing the results may want to see a different set of respondents such as only people within a certain age range, or only people from out of town, or only people of a certain ethnicity, etc.

For most people, simply trying to get the questions to reach enough respondents is too prohibitive and inconvenient so they do not even bother asking. On the other hand, sophisticated research panels, where users can target particular respondent demographics are expensive and are usually only feasible for commercial and academic purposes.

In most of the prior art, recommendation system tries to predict what the asker is interested in and the computer is answering the queries. The filtering logic uses various ways to match the answers by other people who share similar attributes to the current user. The user has no control over the filtering and is only presented with the final answer selected by the algorithm. In such systems the human users only serve as data points to train the computer. Such applications accommodate arbitrary questions from its users. In fact, users cannot ask questions at all and are only able to view recommended items in a certain domain that the system supports (e.g. movies). The system must have a catalogue of all the movies and can only recommend from catalogue.

So there is an obvious need for an improved online question asking, responding, and result processing system with a novel technical architecture and algorithms that enable high speed processing of millions of questions, answers, and demographic attribute filtering, easy-to-use and efficient system to fill these existing gaps in receiving accurate and reliable opinion.

### SUMMARY OF THE INVENTION

The present invention is an online opinion platform application for filtering of poll respondents by demographic attributes which provides a new way for people to ask questions, express their thoughts, and get insight into how other people think. The people can post questions and vote on answers. The answers are expected to be a few words short, and respondents either vote on an existing answer or enter a new answer. The platform application includes processing to control the responders answers and generating different filtering settings and control the application of the filtering; presenting all of the results to the user with rankings and reasons, as opposed to just the top result as determined by algorithm. The platform is designed not to find the best or the right answer, but to let users explore and learn about how all the respondents think and organize questions, answers, votes, and results between human participants.

The operation of the platform is through a non-transitory computer-readable storage media comprising: a computer program including instructions executable by the processing unit to create an online opinion platform and filtering system of poll respondents by demographic attributes application and control the respondents answer, a software module to generate different filtering settings and control the application filtering, a software module configured to use a demographic filtering mechanism to filter respondents among a plurality responds in order to suit each user's needs.

The users of the platform have access to all results and filtering features in order to increase the participation rate. A high participation rate is very important in the quality of the poll results. Users of the platform are not writing separate long messages and are mostly voting on the same answers. This allows the poll results to be arranged by the platform automatically, showing the top X answers from all respondents. This enables the asker and anyone else viewing the results to quickly understand what respondents are thinking without having to read each response. Askers may optionally require all respondents to give reasons of their choices, with the reasons also automatically tabulated and ranked on the result page. This enhances the credibility of the answers.

The users may choose to ask or vote with their identity showing or be anonymous on a per question-basis. The system allows only the registered users to post their responses even if they are posting anonymously. The present invention has design considerations for enhancing trustworthiness and authenticity of responses. Even though any one can sign up to be a user and post/answer questions, they must validate their email address to confirm their identity. Furthermore, the present invention allows users to connect via their Facebook account and use their Facebook name on platform. This earns them an extra icon which enhances their identity validity.

It is therefore an object of the present invention to allow viewers of poll results to filter the results to only respondents with attributes that the viewer is interested in. For example, only respondents from a certain country, or of a certain age range.

It is another object of the present invention to never display user-supplied demographic data to the public and other users, in order to protect user privacy and encourage more users to supply demographic data. It is only used in aggregate for result filtering, question prioritization, or personalization.

It is another object of the present invention to provide a trusted polling system in which the filter cannot be used in a question until there are at least 10 respondents with that particular demographic value. This makes it hard to deduce someone's demographic values by filtering.

It is another object of the present invention to make each filter only available to users who provide their own data first, in order to entice more users to provide their data which in turn makes the whole system more useful. Filters are by default “locked” and can be unlocked by a user by providing his/her own data.

It is another object of the present invention to limit questions and answers to very short in order to reduce efforts needed on the participant part, in order to increase the amount of responses.

It is another object of the present invention in which the respondents may vote on any existing answer or add their new answers.

It is another object of the present invention to allow the users to post anonymously which allows users to ask questions that they do not feel comfortable asking in public or to people they know without showing their name on the post.

It is another object of the present invention to limit the length of questions and answers, as well as designing the interaction flow to be as quick as possible in order to reduce friction and increase participating rate. A vote action can be completed in as little as two clicks.

It is another object of the present invention to provide an exploratory system to let viewers see how different types of people would think about the same question, thus it does not assume only the viewers with the same interest.

It is another object of the present invention to reduces people's anxiety to ask personal questions online; increases participation rate by reducing friction, effort, and anxiety; provides a good balance between anonymity and trustworthiness/credibility of results, and the exploratory nature of supporting the filtering of results differently.

It is another object of the present invention to allow the user to control how filtering is applied and is able to perform different filtering settings to suit his/her own needs.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram of the present invention, and

FIG. 2 shows a schematic view of the present invention.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The system disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

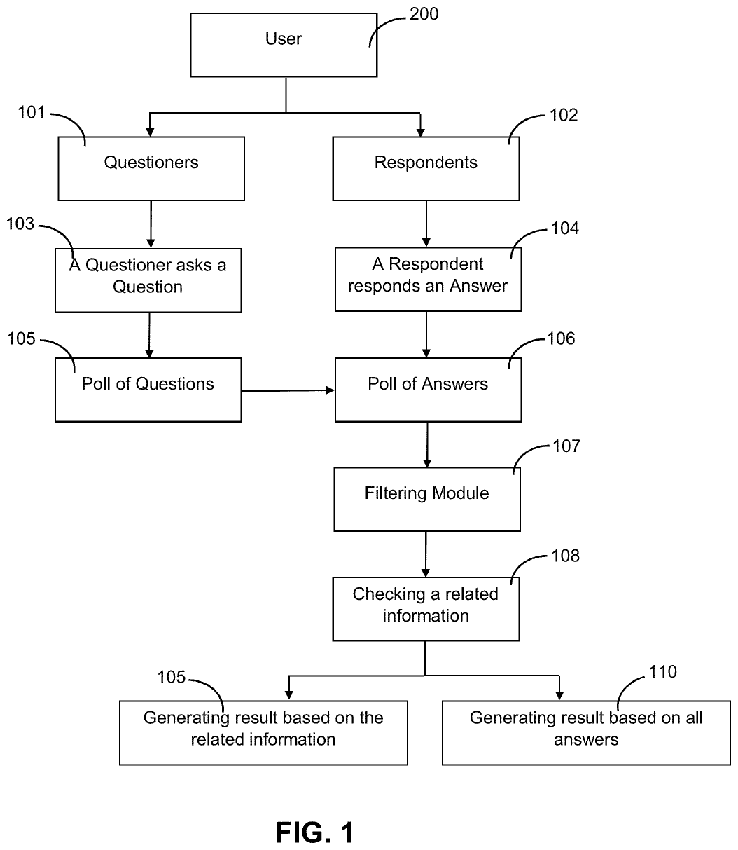

According to FIG. 1, a method and system of an online opinion platform 100 for filtering of poll respondents by demographic attributes are disclosed. The user 200 of the platform 100 comprises of a plurality of questioners 101 who may ask a question and a plurality of respondents 102 who may response to a question. A key requirement for building the online opinion platform 100 of the present invention is, the ability to compute result filtering in real time (milliseconds) over vast amount of questions, answers, reasons, votes and user demographic attributes. A questioner asks a question 103 and provides related information for a specific filtering module and a respondent provides an answer 104 and related information for a specific filtering module. The system checks whether the current user 101, 102 can use the selected filters in the system based on the related information 108 for a specific filtering module 107. The system also generates a poll of questions 105 and a poll of answers 106 in a data base.

The filtering module 107 is only allowed for the users 101, 102 who provided his/her own related information 108 for a specific filtering module 107, for example, if a user wants to filter the results by age range, must first provide his/her own age. The system checks a related information 108 and generates a result based on the requested filter 109. If the related filtering data checked by the system did not satisfied, the system generates the result based on all answers 110.

The privacy of the users is protected by the system in the filtered results. The system is able to “page” the results i.e. return the first X results and then the next X results only upon user request. The filters with the same name are applied in OR logic, and filters with different names/categories are applied with AND logic. For example, the 3 filters (age_range=18-24, 35-44 and country=USA) mean respondents who are (Americans) AND within the (age of 18-24 OR 35-44). As the user is selecting more filters, display in real time the number of filtered respondents that will be left if additional filters are applied, and disables filters that will lead to too few remaining respondents. The system has the ability to perform all of the above steps in sub-second speed over potentially thousands of votes per question.

The users of the platform are not writing separate long messages and are mostly voting on the same answers. This allows the poll results to be arranged by the platform automatically, showing the top X answers from all respondents. This enables the questioner and anyone else viewing the results to quickly understand what respondents are thinking without having to read each response. The questioners may optionally require all respondents to give reasons of their choices, with the reasons also automatically tabulated and ranked on the result page. This enhances the credibility of the answers.

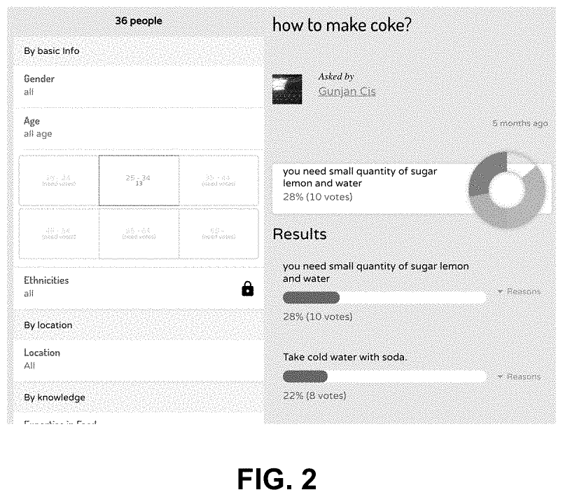

FIG. 2 shows a schematic view of the online platform which user provide his information. A key feature of the online opinion platform is to allow viewers of poll results to filter the results to only respondents with attributes that the viewer is interested in. For example, only respondents from a certain country, or of a certain age range. The filters in the platform are based on Gender, Age range, Ethnicities, Country, Region, Province/State, City, Expertise level in the question's topic, Cultural origin, Occupation, Relationship status, Has children, Household status, Political views, and Religion.

The demographic data is voluntarily supplied by users. For this filtering to be useful, it is important for more users to be willing to provide their data. There are two challenges to this: “Concerns over privacy” and “Lack of incentive to provide the data”.

The users may choose to ask or vote with their identity showing or be anonymous on a per question-basis. The present invention never displays user-supplied demographic data to the public nor to other users. It is only used in aggregate for result filtering, question prioritization, or personalization. A filter cannot be used in a question until there are at least 10 respondents with that particular demographic value. Each filter is only available to users who provide their own data first. Filters are by default “locked” and can be unlocked by a user by providing his/her own data.

According to table 1 the algorithms to report filtered poll results are mainly broken down into 4 SQL functions as below. The techniques described here store and process all the data in a SQL database. The following tables are simplified to show just the parts relevant to the filtering algorithm.

| | | |
|---|---|---|
| Table name | Purpose | Columns |

Basic Data

| | | |
|---|---|---|
| user | A user on the platform, who | ID, name. |
| | may ask and respond to | |
| | questions. | |
| question | Store the questions. | ID, user_id (who asked the |
| | | question), title (the question |
| | | text), votes (total votes on |
| | | this question). |
| answer | Answers to a question, | ID, question_id, user_id |
| | including both pre- | (who first added this |
| | populated answers by the | answer), value (text of the |
| | asker and additional | answer), votes (total |
| | answers by voters. | unfiltered votes). |
| reason | Reasons on an answer, | ID, answer_id, user_id (who |
| | respondents may pick | first added this reason), |
| | existing reasons or enter | value (text of the reason), |
| | new reasons. | votes (total unfiltered votes). |

Demographic Data

| | | |
|---|---|---|
| demo_attribute | Static dimension table that | ID, name (e.g. gender), |
| | maps demographic filter | value (e.g. male) |
| | values to a numeric ID. | |
| demo_profile | Provide a snapshot of a | ID, user_id. |
| | respondent's entire set of | |
| | demographic values at the | |
| | moment a vote is cast. The | |
| | user may have provided | |
| | none, few, or all | |
| | demographic data and this | |
| | is used as the basis of | |
| | filtering. | |
| demo_profile_to_demo_attribute | Relationship table. | ID, demo_profile_id, |
| | | demo_attribute_id. |

Vote Data

| | | |
|---|---|---|
| respondent | Each time a user casts a | ID, question_id, user_id, |
| | vote on a question, he/she | demo_profile_id. |
| | is a respondent. The user's | |
| | demo profile at the time of | |
| | voting is marked here. | |
| response | Links the answer(s) | ID, respondent_id, |
| | selected by the respondent. | answer_id. |
| | Currently only one answer | |
| | is allowed so this table is | |
| | 1:1 relationship with | |
| | respondent. | |
| response_to_reason | Links the reasons for each | ID, response_id, reason_id. |
| | response. Each response | |
| | may have zero to many | |
| | reasons. | |

Denormalized table for performance

| | | |
|---|---|---|
| result_answer | Key table to support the | ID, questioned, |
| | filtering algorithm. | demo_attribute_id, |
| | Index 1: question_id + | response_id. |
| | demo_attribute_id + | |
| | response_id. | |
| | Index 2: response_id. | |

The algorithms to report filtered poll results are mainly broken down into 4 SQL functions:
result_answers( ): the main function that computes filtered responses (answers) of a question based on the current user's (whom is viewing the result page) selected filters.
result_reasons( ): support function that returns reasons linked to the answers output from result_answers.
result_respondents( ): support function that returns respondents who voted on the reasons.
subfilters( ): support function that returns total votes, currently filtered votes, next level of filtered votes if the user applies more filters, and which filters can still be used by the user on top of the currently applied filters.

### Result_Answers( )

The inputs to the result_answers( ) function comprises of:
question_id;
viewer_id (i.e. the user id of the person viewing the results);
demo_pairs;
   This is a table input to the function, of the viewer's selected filters. This table is a name-value pairs (i.e. two columns: name & value),
   This gets mapped to demo_attribute_id's via joining with the demo_attribute table,
cursor_id (for paging purpose, answer_id of the last answer in a previous call to the same function), and
range (number of results to output).

The steps of the algorithm comprise of following:
1. Create a temporary table answer_filtered to store all answers that pass the filter.
2. If demo_pairs is empty (i.e. no filtering applied), insert all answers for the question into answer_filtered.
3. If demo_pairs is not empty, perform the following steps:
   a. Validation 1: If any filter in demo_pairs cannot be converted to demo_attribute_id (i.e. unknown value), return an error.
   b. Validation 2: If any filter is not allowed to be used (i.e. viewer has not provided his/her own data for this demographic category), return an error.
   c. Create a temporary table size_est (name, value, demo_attribute_id, size_est, group_size). This is used to estimate the data size of each of the demo filter value in demo_pairs. This is the key to high performance filtering as we want to apply the filter that will rule out the most number of respondents first to keep data size small.
      i. When filtering more than one demo attribute, (e.g. Female & Engineers) we need to identify respondents who are both female and engineers. A key fact is that some demographic attributes have high data cardinality (e.g. occupation) than others (e.g. gender). We can exploit this fact to quickly reduce the data size by first processing the attributes with high cardinality (i.e. occupation in this case). This data size estimation is a key technique to high performance filtering.
   d. The size_est table is filled with same number of rows as in demo_pairs. For each demo value, calculate the following using database's statistics (this should be a quick operation regardless of data size):
i. Size_est: the estimated number of rows from result answer table where question_id is this question, and demo_attribute_id is this current demo value's ID.
ii. Group_size: the sum of size_est of all rows with the same demo name. (e.g. sum of size_est for all ethnicity filters applied)
iii. Order size_est by smallest group_size first, then by largest size_est within each group. We want to apply the filters in an order that allow us to filter out the most number of respondents.
iv. Database statistics is internal data that the database engine maintains for its own operation. Usually the application logic does not utilize this data. We are exploiting this data for our purpose without adding additional overhead to maintain our own statistics. The database statistics is not exact count, but a close estimate which is good enough for our purpose of ranking the various filter attributes by uniqueness/cardinality. This statistic is specific to the exact question that we are trying to filter on. Different questions attract different kinds of respondents so we cannot assume a global statistic will suffice.
e. Create a temporary table resp_filtered which has only one column: response_id. This table is used to store the current list of response_ids that passed the filter checks.
   i. Maintain another similar temporary table called last_resp_filtered, which is the last used version of resp_filtered.
f. For every row in the size_est temporary table, perform the following computation.
   i. This is purposely designed to execute in a loop row by row as opposed to a single query. The sorting order of size_est allows the quick reduction of processing data size and leads to better performance.
   ii. This may seem counter-intuitive because for most database queries it is faster to run a single query that produces the entire output needed, than iteratively building the output like this. For this algorithm, the iterative approach is better because it minimizes work-in-progress data size and memory requirement, resulting in higher performance. It minimizes the total number of rows the algorithm needs to process at any point in time, leading to higher performance when there are thousands or millions of votes.
g. If the current demo name has changed (e.g. from “gender” to “age_range”), replace last_resp_filtered with resp_filtered, and reset resp_filtered to empty.
   i. No table rotation is done if the demo name is unchanged and only demo value is changed.
h. Insert the response_ids in result_answer table that overlap all previously matched demo types (i.e. “IN (SELECT response_id FROM last_resp_filtered)”) and union with matches in the current demo types (i.e. “NOT IN (SELECT response_id FROM resp_filtered)”).
   i. This performs the AND logic across different demo names, and OR logic within the different values in the same demo name.
i. End of loop.
4. Joining resp_filtered (which contains only response_ids) with response and answer tables to produce a new temporary table called “answer_filtered”. This contains all the data attributes needed for the output.
5. Return the requested rows in answer_filtered based on input cursor_id and range.
6. Both the resp_filtered and answer_filtered tables remain in the database transaction to be used as input data to the three other functions in this algorithm: result_reasons, result_respondents, subfilters.

### Result_Reasons( )

This function is designed to be used in conjunction with result_answers( ). It is called right after result_answers, in the same database transaction. Temporary tables created by result_answers remain in the session as inputs to this result_reasons function.

Inputs to this function comprises of:
question_id;
viewer_id (i.e. the user_id of the person viewing the results);
answer_filtered (temporary table that remains after call to result_answers);
resp_filtered (temporary table that remains after call to result_answers);
cursor_id (for paging purpose, reason_id of the last reason in a previous call to the same function), and
range (number of results to output)

The steps of the algorithm comprise of following:
1. If no demo filtering is used, return output by joining answer_filtered and reason table.
2. If demo filtering is used, create a temporary table called reason_filtered and populate it using resp_filtered, response_to_reason, and reason tables.
3. Return the requested rows in reason_filtered based on input cursor_id and range.

### Result_Respondents( )

This function outputs respondent's data for a reason_id. Because we only output respondents in unfiltered results, this function can be used standalone, without needing access to the filtered data created by result_answers.

Inputs to this function comprises of:
question_id
viewer_id (user_id who is requesting this function)
reason_id (the reason that we return a list of respondents for)
cursor_id
range

The steps of the algorithm comprise of following:
1. Return output by joining the input parameters to the respondent, response, response_to_reason, question, and user tables.
2. Limit the amount of output by cursor_id and range.

### Subfilters( )

This function returns the list of usable (i.e. at least 10 respondents) demo filter values (e.g. single, married, divorced) under one demo name (e.g. relationship_status) given that a set of other filters are already applied (e.g. gender=male & country=USA). This allows the system to tell users which filtering options they can select and the expected number of filtered respondents, while they are in the process of selecting more filters.

The output is a list of filter values and respondents counts and the inputs to this function comprises of:
question_id
viewer_id
check_type: the demographic name (e.g. relationship_status) to perform the check on
resp_filtered: temporary table created by a previous call to result_answers( )

The steps of the algorithm comprise of following:
1. Perform a validation first on the requested check_type against the viewer's supplied demographic data in his/her demo_profile. A user must provide own data before using the same demo type in a filter.
2. Join all values in demo_attribute table where name=check_type to the result_answer table on the list of respondent_ids in the resp_filtered table (generated earlier by a call to result_answers( )).
   a. Group by demo_attribute.value and get a count of rows per value. This gives us number of respondents per demo value under this check_type.
3. Output everything with count >=10. As a design requirement of the system, values with fewer than 10 respondents cannot be used as filters.

It will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations).

The machine readable medium may provide instructions on which any of the methods disclosed herein may be performed. The instructions may provide source code and/or data code to the processor to enable any one or more operations disclosed herein.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A computer-implemented method of online opinion for filtering of poll respondents by demographic and credibility attributes, said method comprising:
a) providing a plurality of questions by a plurality of questioners, wherein each said questions are assigned a topic;
b) receiving a plurality of answers by a plurality of respondents, wherein each said respondents has different level of expertise in said topic;
c) receiving a plurality of votes for said answers by said respondents;
d) receiving a plurality of reasons for said answers or said votes by said respondents;
e) storing a demographic profile data of said respondent at a time of response to the question, vote or provide reason;
f) analyzing a related data for said questioners and said responders based on a selective filtered module;
g) providing an answer with most votes out of all respondents, all ranked answers, all ranked reasons for each said answers;
h) filtering said answers based on demographic settings and credibility of said respondent, wherein the filtering step comprises of creating a temporary table to estimate the data size of each of a demo filter value by a database statistic to keep data size small for high performance filtering;
i) executing in a loop row by row for every row in the temporary table by an iterative approach to minimize work-in-progress data size and memory requirement, resulting in higher performance, and
j) ranking said answers, wherein said ranking is by highest number of votes within the filtered set of respondents.

2. The computer-implemented method of online opinion of claim 1, wherein said iterative approach minimizes the data size and memory requirements to achieve higher performance.

3. The computer-implemented method of online opinion of claim 1, wherein said database statistics is an internal data that a database engine maintains for its own operation and is not exact count to rank the various filter attributes by uniqueness/cardinality, whereby said database statistics achieves high performance without the overhead of maintaining its own statistics.

4. The computer-implemented method of online opinion of claim 1, wherein said questioners and respondents provide said questions and answers in an anonymous way.

5. The computer-implemented method of online opinion of claim 1, wherein said method provides a specific answer based on the selective filtered module.

6. The computer-implemented method of online opinion of claim 1, wherein said selective filtered module available for questioner and respondents which provide the related for a specific filtering module.
